(19) United States
(12) Patent Application Publication
(10) Pub. No.: US 2003/0116510 A1
(43) Pub. Date: Jun. 26, 2003

(54) In situ fluid treatment system and process

(76) Inventor: Paul J. Usinowicz, Powell, OH (US)

Correspondence Address: STANDLEY & GILCREST LLP, 495 METRO PLACE SOUTH, SUITE 210, DUBLIN, OH, 43017, US

(21) Appl. No.: 09/975,407

(22) Filed: Oct. 11, 2001

(51) Int. Cl. C02F 1/00

(52) U.S. Cl. 210/767

(57) ABSTRACT

A system and process for the in situ treatment of a fluid. In particular, the fluid in a naturally occurring source is treated in situ. The system uses an in situ fine porous device to remove at least a portion of at least one undesired component from a flowing fluid. If necessary, the flow may be induced by a pump of the system. The treated fluid is then transferred from the naturally occurring source, whereas the undesired components that have been removed from the treated fluid are left in the naturally occurring source. After being transferred from the naturally occurring source, the fluid can be used as is, or the fluid can undergo further treatment, if necessary.

### BACKGROUND OF THE INVENTION

The present invention relates generally to the treatment of fluids and, more particularly, to the in situ treatment of naturally occurring bodies of fluid. Fluids, e.g., gases and liquids, have a broad range of uses including, but not limited to, drinking, commercial, recreational, and industrial uses. Fluids are often withdrawn from naturally occurring sources for such use at other locations.

Naturally occurring bodies of fluid can include components that render the fluid unsatisfactory for certain uses. For example, sediment, pathogens, contaminants, germs, microorganisms, and various undesired solid particles can accumulate in naturally occurring bodies of fluid. Before the fluid can be used, it is often necessary to remove some or all of these undesired components from the fluid.

In some fluid treatment systems, the fluid is removed from the naturally occurring source along with the undesired components. At a remote location, the fluid is then treated to remove the undesired components such that the fluid is suitable for the intended use. Thereafter, the fluid is distributed to the location of its intended use. On the other hand, care must be taken to properly dispose of the undesired components that have been removed from the fluid. Most importantly, laws or regulations may make it illegal to return the undesired components to the naturally occurring source of the fluid. As a result, the time and cost of properly disposing of the undesired components that have been removed can be significant.

In light of the drawbacks of removing the undesired components from the naturally occurring body of fluid, there is a need for a treatment process and system that do not remove the undesired components from the naturally occurring body of fluid. Another need exists for a system and process that more efficiently treat the fluid, thereby reducing the time and cost of treating the fluid. A need also exists for a treatment system and process that do not require a remote facility for treating the fluid.

### SUMMARY OF THE INVENTION

The present invention provides a system and process for the in situ treatment of a fluid. In particular, the fluid in a naturally occurring source is treated in situ. The treatment removes at least a portion of at least one undesired component from the treated fluid. The treated fluid is then transferred from the naturally occurring source, whereas the undesired components that have been removed from the treated fluid are left in the naturally occurring source. After being transferred from the naturally occurring source, the fluid can be used as is, or the fluid can undergo further treatment, if necessary.

One example of the present invention is a process for treating a naturally occurring body of fluid. The process comprises providing a fine porous device and positioning the fine porous device in the body of fluid. A portion of the body of fluid is then passed through the fine porous device. Thereafter, the portion of the body of fluid is transferred to a location away from the remainder of the body of fluid.

The body of fluid may include at least one undesired component. At least a portion of the at least one undesired component may be blocked with the fine porous device such that the portion of the at least one undesired component is left in the remainder of the body of fluid.

The process may further include providing a coarse screen. The coarse screen may be positioned in the body of fluid such that a portion of the body of fluid passes first through the coarse screen and then through the fine porous device. A pump may also be provided. The pump may be positioned in the body of fluid to induce a flow of a portion of the body of fluid to be treated or an alternate, supplementary fluid to pass across the surface of the fine porous device. Another pump may also be provided such that it is in fluid communication with the portion of the body of fluid that has passed through the fine porous device. This pump may be used to transfer the portion of the body of fluid to a location away from the remainder of the body of fluid.

A structural support for the fine porous device may also be provided. The fine porous device may be secured to the structural support. The fine porous device and the structural support may be positioned in the body of fluid either before or after being secured together. The structural support may be a housing for the fine porous device.

A pump may also be provided for providing a reverse flow of a fluid. The pump may be placed in fluid communication with the fine porous device and another source of a fluid. The fluid from the other source may then be pumped into the body of fluid to clean the fine porous device.

Another example of the present invention is process for treating a naturally occurring body of water that includes at least one undesired component. This process may include any of the optional or preferred features of the above-described example. This exemplary process provides a porous membrane, as an example of the fine porous device, a structural support, a screen, and a pump. The porous membrane may be secured to the structural support, and the porous membrane, the structural support, and the screen may be positioned in the body of water. A portion of the body of water may be passed through the screen and then through the porous membrane. At least a portion of the at least one undesired component is blocked with the porous membrane such that the portion of the at least one undesired component is left in the remainder of the body of water. The pump is placed in fluid communication with the portion of the body of water, and it is adapted to transfer the portion of the body of water to a location away from the remainder of the body of water. The portion of the body of water is then transferred to the location away from the remainder of the body of water.

Another embodiment of the present invention is a fluid treatment system. The fluid treatment system may include any of the optional or preferred features of the above-described examples of the present invention. An example of the fluid treatment system comprises a naturally occurring body of fluid that includes at least one undesired component. A coarse screen may be positioned in the body of fluid. Also, a fine porous device is positioned in the body of fluid such that a portion of the body of fluid may pass through the coarse screen and then through the fine porous device. The fine porous device is adapted to block at least a portion of the at least one undesired component when the portion of the body of fluid passes through the fine porous device. A conduit is provided having a first end portion and a second end portion. The first end portion is positioned in the body of fluid such that it is adapted to be in fluid communication with the portion of the body of fluid that has passed through the fine porous device. On the other hand, the second end portion is positioned outside of the body of fluid. A pump may be located outside of the body of fluid and connected to the second end portion of the conduit. The pump is adapted to transfer the portion of the body of fluid to the second end portion of the conduit.

In addition to the novel features and advantages mentioned above, other objects and advantages of the present invention will be readily apparent from the following descriptions of the drawings and exemplary embodiments.

### BRIEF DESCRIPTION OF THE DRAWINGS

FIG. 1 is a perspective view of an example of a fluid treatment system of the present invention;

FIG. 2a is a plan view of an exemplary implementation of a fluid treatment system of the present invention in a flowing source;

FIG. 2b is an elevation view of the implementation of FIG. 2a;

FIG. 3a is a plan view of an exemplary implementation of a fluid treatment system of the present invention in a non-flowing, fluid source;

FIG. 3b is an elevation view of the implementation of FIG. 3a;

FIG. 4a is a plan view of an exemplary implementation of a fluid treatment system of the present invention in a non-flowing, fluid source, with a supplementary fluid for cleansing the fine porous device from the fluid source side of the fine porous device;

FIG. 4b is an elevation view of the implementation of FIG. 4a;

FIG. 5a is a plan view of an exemplary implementation of a fluid treatment system of the present invention with the in situ fine porous device in a vertical orientation;

FIG. 5b is an elevation view of the implementation of FIG. 5a;

FIG. 6a is a plan view of an exemplary implementation of a fluid treatment system of the present invention with the in situ fine porous device in a horizontal orientation;

FIG. 6b is an elevation view of the implementation of FIG. 6a;

FIG. 7a is a plan view of an exemplary implementation of a fluid treatment system of the present invention with the in situ fine porous device in an inclined orientation;

FIG. 7b is an elevation view of the implementation of FIG. 7a;

FIG. 7a is an elevation view of an exemplary implementation of a fluid treatment system of the present invention with coarse screening;

FIG. 8b is a plan view of the implementation of FIG. 8a;

FIG. 9a is a plan view of an example of a unitary fluid treatment system of the present invention; and

FIG. 9b is an elevation view of the unit of FIG. 9a.

### DETAILED DESCRIPTION OF EXEMPLARY EMBODIMENT(S)

The present invention is directed to an in situ fluid treatment system and process. The present invention will be described primarily herein with regard to treating a source of water or air. Nevertheless, the present invention may be used to treat any type of liquid or gas fluid. Furthermore, the present invention may be used to treat any type of source of the fluid. Examples of naturally occurring sources of fluid include oceans, gulfs, seas, lakes, ponds, streams, rivers, creeks, quarries, lagoons, channels, swamps, other bodies of fluid surrounded or defined by land or otherwise located on the earth's surface, and other similar bodies of fluid. Further examples of naturally occurring sources of fluid include the atmosphere and other similar bodies of fluid. With regard to each of the examples, it should be recognized that a naturally occurring source of fluid may be man-made or have man-made boundaries, e.g., a man-made lake or a lake having a dam as a boundary.

A naturally occurring source of fluid may include at least one component that is not suitable for a desired use of the fluid. Examples of undesired components include, but are not limited to, sediment, various other solids suspended in the body of fluid, pathogens, contaminants, germs, microorganisms, metal ions, aqueous salt, sugar, synthetic dyes, endotoxins, pyrogens, carbon black, viruses, tobacco smoke, gelatin, colloidal silica, albumin protein, paint pigment, bacteria, blue indigo dye, blood, dust, latex materials, emulsions, asbestos, milled flour, giardia cysts, yeast cells, coal dust, pollen, hair, sand, granular activated carbon, and other similar or known undesired components. Examples of pathogens include, but are not limited to, bacteria, protozoa, amoeba, viruses, and other similar or known organisms. Additionally, examples of microorganisms include, but are not limited to, giardia cysts, cryptosporidium, pseudomonas, E-coli, legionella, bacteria, coliform, protozoan oocysts, algae, and viruses. Furthermore, examples of other solids that may become suspended in the body of fluid include, but are not limited to, metals, inorganic solids, organic compounds, and other similar or known solids.

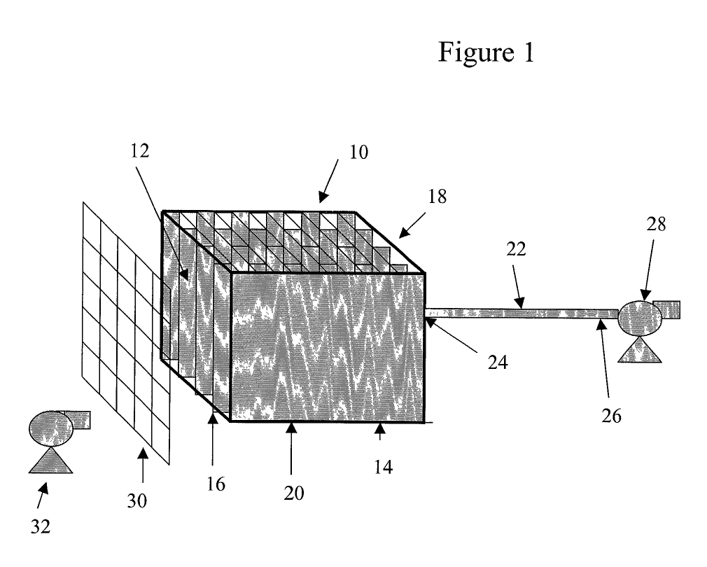

FIG. 1 shows an example of a fluid treatment system 10 of the present invention. The system includes at least one fine porous device 12. The fine porous device 12 is adapted to be suspended in a source of fluid. In addition, the fine porous device 12 is adapted to allow the passage of a portion of the fluid while blocking at least a portion of at least one undesired component in the fluid. The fine porous device 12 may be comprised of any suitable material including, but not limited to, plastics, textiles, metals, ceramics, cellulosic materials, and other similar, suitable, or conventional materials. Examples of the fine porous device 12 include, but are not limited to, ultrafilter membranes, microporous membranes, porous membranes, microscreens, nanofilters, reverse osmosis membranes, particle filters, and other similar, suitable, or conventional separation materials for filtering a fluid. A commercially available example of a porous membrane 12 is a microporous membrane from Zenon Environmental Services of Ontario, Canada.

The porosity of the fine porous device 12 may be selected based on the fluid, the amount and type of undesired components, the flow rate of the fluid, and the desired degree of undesired component separation. Each of the aforementioned exemplary embodiments of fine porous devices are commercially available in a range of sizes that are well known in the art. Table 1 illustrates the sizing for some embodiments of the fine porous devices. Other embodiments of the fine porous devices may have sizes outside of the ranges shown in Table 1.

[image]

Optionally, the fine porous device 12 may be secured to a structural support 14. The structural support 14 may be used for maintaining the position and/or shape of the fine porous device 12 in the fluid. The fine porous device 12 may be secured to the structural support 14 by any suitable means. For example, the fine porous device 12 may be secured to the structural support 14 with mechanical fastening means including, but not limited to, nails, screws, hinges, hooks, bolts, clamps, female connecting portions, male connecting portions, posts, receptacles, rods, axles, pins, chains, sprockets, belts, pulleys, springs, balls, sockets, hinges, trunnions, and clips. For another example, the fine porous device 12 may be secured to the structural support 14 using an interference fit.

The structural support 14 may have any suitable shape for maintaining the position and/or shape of the fine porous device 12 in the fluid. Optionally, the structural support 14 may substantially contain the fine porous device 12, i.e., the structural support 14 may be a housing. Regardless of the shape of the structural support 14, the structural support 14 allows a flow of the fluid through the fine porous device 12. If necessary, the structural support 14 has at least one inlet portion 16 and outlet portion 18. The structural support 14 may also have at least one side wall portion 20 to block a flow of the fluid from an undesired direction and/or to protect the fine porous device 12.

The structural support 14 may be made of any suitable material. Examples of suitable materials include, but are not limited to, metal, wood, plastics, concrete, and other similar, suitable, or conventional structural materials. For instance, the structural support 14 may be made of steel.

A pipe, conduit, or any other similar, suitable, or conventional type of transfer passage is adapted to receive a flow of a fluid that has passed through the fine porous device 12. In the example of FIG. 1, a pipe 22 is adapted to receive a flow of the fluid that has passed through the fine porous device 12. For example, an inlet portion 24 of the pipe 22 may be: connected directly to the fine porous device 12; connected directly to the outlet portion 18 of the structural support 14; located adjacent the fine porous device 12; located adjacent the outlet portion 18 of the structural support 14; and/or located anywhere in the body of fluid such it is in fluid communication with a flow of the fluid that has passed through the fine porous device 12. The pipe 22 or any other suitable transfer passage enables a flow of the fluid that has passed through the fine porous device 12 to be withdrawn from a remainder of a body of fluid. In an exemplary embodiment, the system may be effectively sealed such that only fluid that has passed across the fine porous device 12 may enter the pipe 22.

An outlet portion 26 of the pipe 22 may be placed in fluid communication with a pump 28. The pump 28 may be any type of pump suitable for pumping a fluid. The pump 28 may be used to draw the treated fluid through the pipe 22 away from the undesired components that have been blocked by the fine porous device 12. Additionally, the pump 28 may be used to transfer the treated fluid to a location for further treatment or to a location where it may be used as is. Furthermore, the pump 28 may be used to provide a reverse flow of a fluid for cleaning purposes. For example, the pump 28 may be used to withdraw fluid from the source through pipe 22, and then reverse the flow back into the source to clean the fine porous device 12. For another example, the pump 28 may be in fluid communication with another source of a fluid, and the pump 28 may be used to transfer fluid from the other source through the pipe 22 to the fine porous device 12. In this manner, the fine porous device 12, the structural support 14, and/or the inlet portion of the pipe 22 may be cleaned. The fluid used for cleaning purposes may be the same as the fluid in the naturally occurring source or a fluid that includes cleaning agents.

Optionally, a coarse screen 30 may be provided. The coarse screen 30 may be used to provide additional filtration of the fluid. The coarse screen 30 may also be used to protect the fine porous device 12. For instance, the coarse screen 30 may be used to block relatively large solid objects that are suspended in the fluid from reaching and damaging the fine porous device 12. The porosity of the coarse screen 30 may be selected based on the desired degree of filtration, the desired degree of protection, and the type and size of the solids suspended in the fluid. The coarse screen 30 may be made of any material that is suitable for the intended purpose. Examples of suitable material include, but are not limited to, metal, wood, plastics, concrete, and other similar, suitable, or conventional structural materials. For instance, the screen 30 may be made of steel.

The system 10 may also include another pump 32. The pump 32 may be disposed in the naturally occurring source of fluid. The pump 32 may be used to induce a flow of the fluid across the surface of the fine porous device 12. The purpose of the pumping may be to provide a cleansing or scouring action by the flow of the fluid across the fine porous device. The pump 32 may be any type of pump that is suitable for pumping or otherwise moving a fluid. It should be recognized that the pump 32 may be embodied as a fan or any other similar, suitable, or conventional device. The pump 32 may be used in any type of fluid source. The pump 32 is particularly useful when the fine porous device 12 is positioned in a fluid source that has an insufficient or otherwise unsuitable flow pattern. However, the pump 32 may also be used in fluid sources that have strong or otherwise suitable flow patterns.

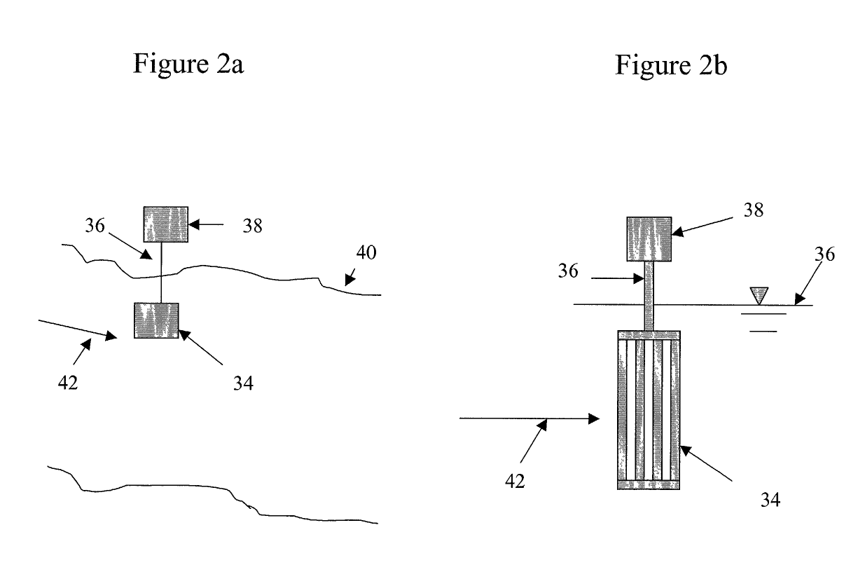

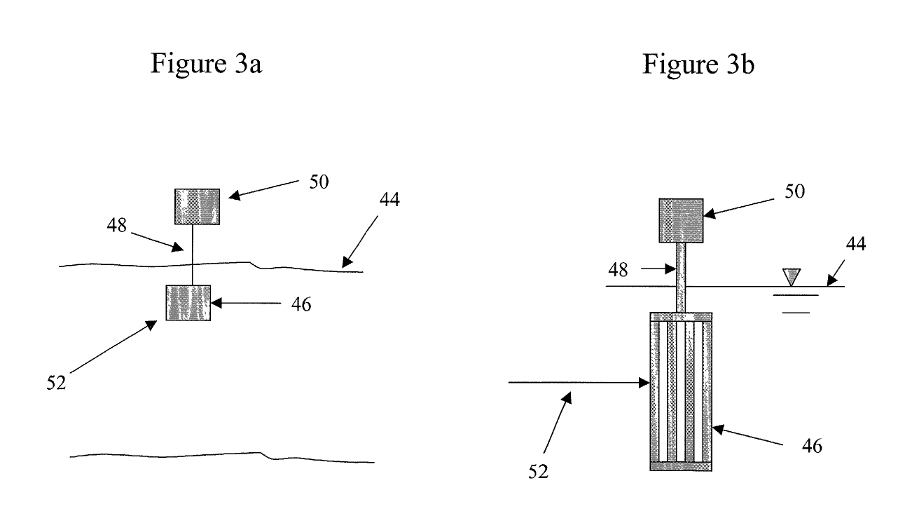

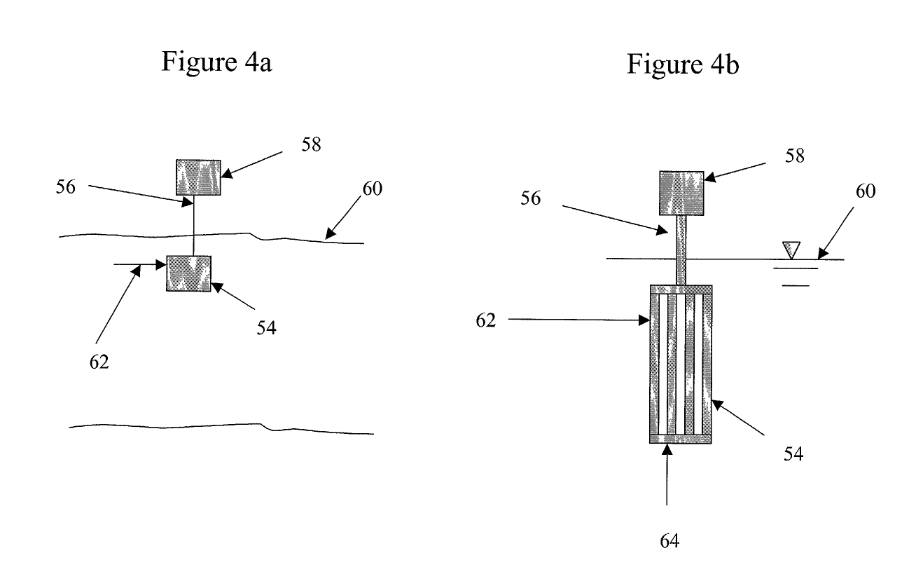

As just noted, the present invention may be used to treated flowing as well as non-flowing sources of fluid. FIGS. 2a and 2b show the present invention being used to treat a flowing source, e.g., a source that has a flow induced by gravity or other natural forces. This embodiment of the treatment system includes an in situ fine porous device 34, a pipe 36, and a pump station 38. The fine porous device 34 is positioned in a source of fluid 40 that is flowing in the direction 42. On the other hand, FIGS. 3a and 3b depict a system of the present invention being used to treat the liquid fluid of a non-flowing source 44. The exemplary treatment system comprises an in situ fine porous device 46, a pipe 48, and a pump station 50. Since the source 44 is normally non-flowing, a pump, a fan, or any other suitable device is used to induce a flow as indicated by arrow 52 through the fine porous device 46. Similarly, FIGS. 4a and 4b show a system including an in situ fine porous device 54, a pipe 56, and a pump station 58 being used to treat a non-flowing gas source 60 in which flows have been induced as indicated by arrows 62 and 64.

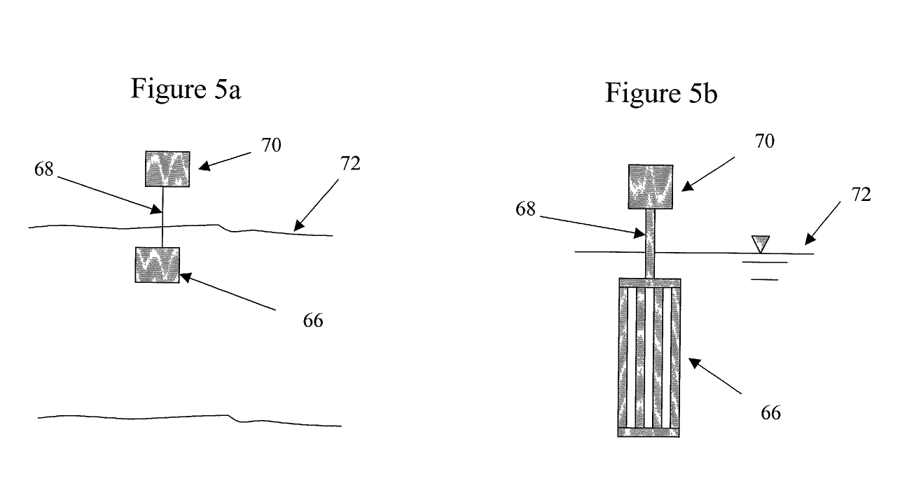

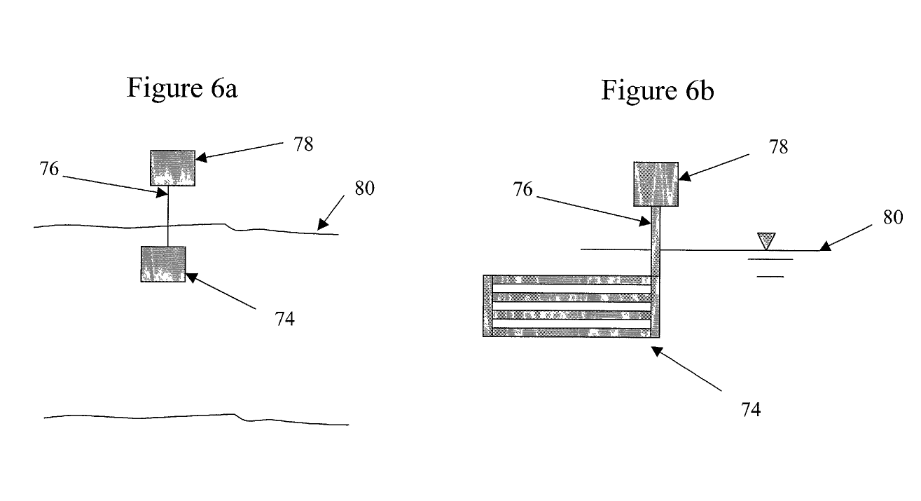

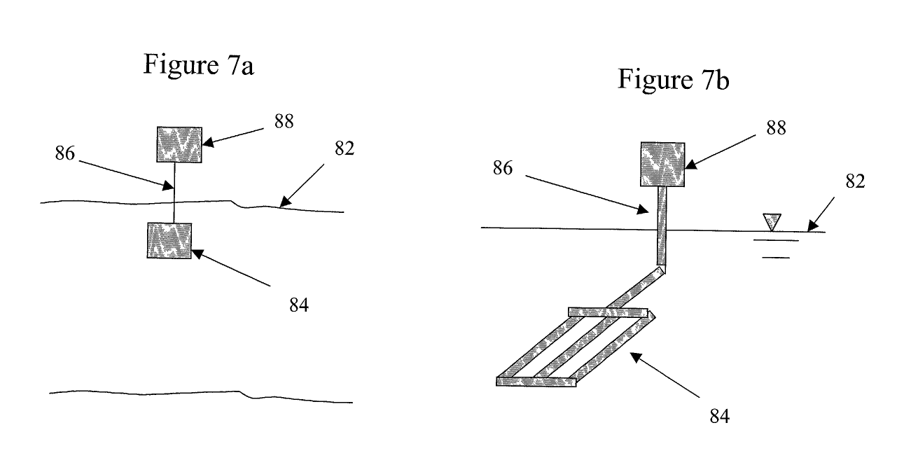

The fine porous device of the treatment system may have any orientation that enables the passage of a flow of fluid while blocking at least a portion of at least one undesired component in the fluid. Factors that may be involved in selecting the orientation of the fine porous device include the direction of the flow, the type of flow, and the type and size of the undesired components in the flow. FIGS. 5a and 5b show an exemplary treatment system including an in situ fine porous device 66, a pipe 68, and a pump system 70 being used to treat a fluid source 72, wherein the in situ fine porous device 66 is vertically oriented. On the other hand, FIGS. 6a and 6b depict a horizontally-oriented in situ fine porous device 74, a pipe 76, and a pump station 78 being used to treat a fluid source 80. In yet another embodiment, FIGS. 7a and 7b show a fluid source 82 that is being treated by a treatment system that includes an in situ fine porous device 84 having an inclined orientation, a pipe 86, and a pump station 88.

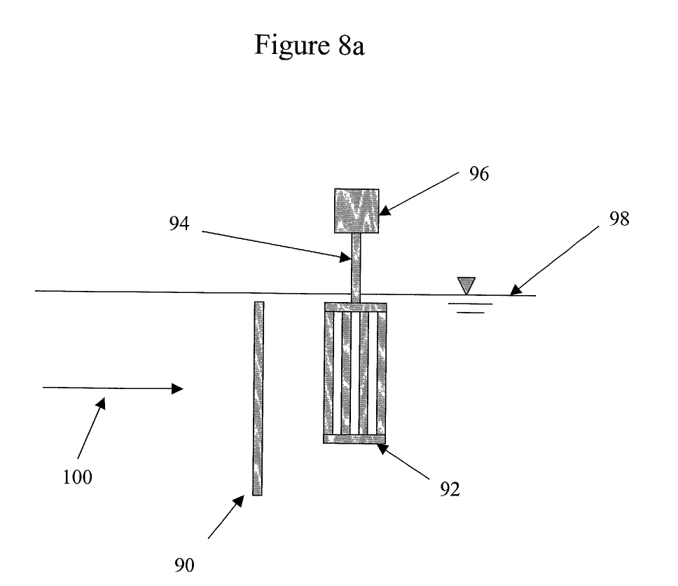

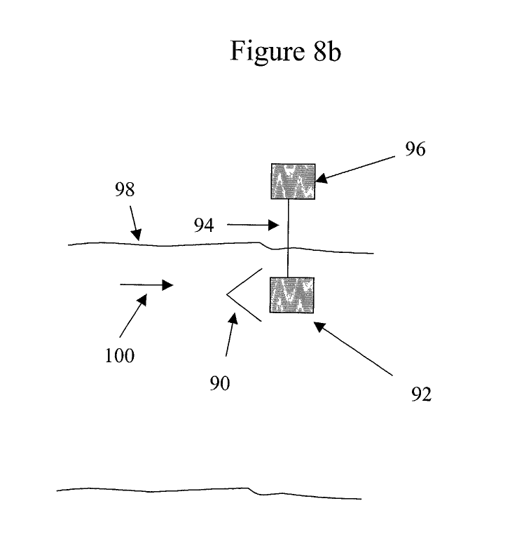

As discussed above, a treatment system of the present invention may include a screen. In FIGS. 8a and 8b, an exemplary treatment system is shown that includes a bar screen 90, a fine porous device 92, a pipe 94, and a pump station 96. The bar screen 90 and the fine porous device 92 are situated in a fluid source 98 having a flow in the direction of arrow 100. The bar screen 90 may have any suitable shape. In this example, the bar screen 90 has a V-shape for directing certain undesired components around the fine porous device 92, thereby providing additional filtering capacity as well as protecting the fine porous device 92 from potential damage.

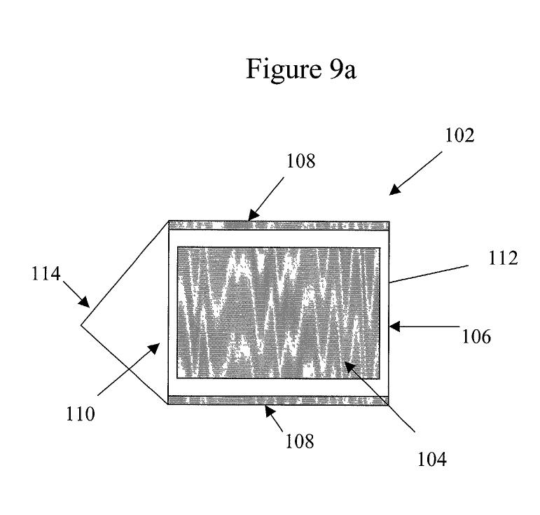

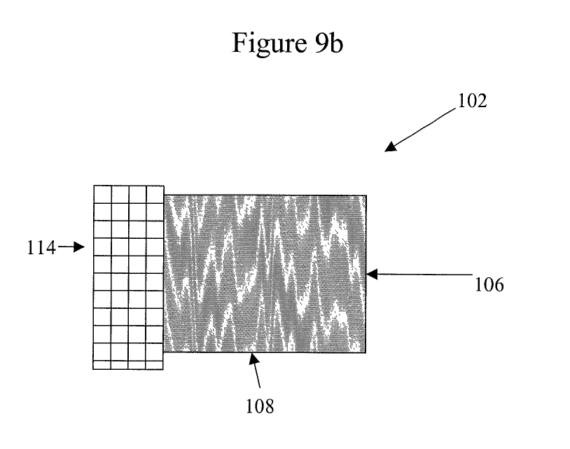

The treatment system of the present invention may be formed as a single unit or multiple units. FIGS. 9a and 9b show an exemplary embodiment of a unitary treatment system 102 of the present invention. In this embodiment, the fine porous device 104 is secured within a support system 106. The support system 106 includes side walls 108, an inlet structural support 110, and an outlet structural support 112. If desired, each of the side walls 108 may be non-porous so as to prevent a flow path in that particular direction. The inlet structural support 110 and the outlet structural support 112 connect the side walls 108 while providing a flow path to and from the fine porous device 104. In this example, the bar screen 114 is integrally connected to the side walls 108 and/or the inlet structural support 110. As a result, the treatment system 102 may be moved as a single unit.

As noted above, the treatment system may reverse the flow of fluid back across the fine porous device for cleaning purposes. In addition, the treatment system can be constructed and installed such that the natural flow transports the undesired components away from the fine porous device. In addition, the components of the treatment system may be cleaned by scouring, such as induced by fluid flow pumped across the fine porous device surface on the fluid source side. The fluid used may be the fluid to be treated, or may be composed of another fluid, solely, or in concert with the fluid to be treated. For example, treatment of water may incorporate pumping water across the fine porous device for cleaning or scouring, and may be further enhanced by also pumping air singularly or simultaneously across the membrane.

The present invention may be used alone or in conjunction with other conventional or new treatment methods. For example, the present invention may be used in conjunction with chemical treatment methods. The use of additional treatment methods in addition to the present invention may or may not be advisable depending on the intended use of the fluid.

The exemplary embodiments herein disclosed are not intended to be exhaustive or to unnecessarily limit the scope of the invention. The exemplary embodiments were chosen and described in order to explain the principles of the present invention so that others skilled in the art may practice the invention. Having shown and described exemplary embodiments of the present invention, those skilled in the art will realize that many variations and modifications may be made to affect the described invention. Many of those variations and modifications will provide the same result and fall within the spirit of the claimed invention. It is the intention, therefore, to limit the invention only as indicated by the scope of the claims.

What is claimed is:

1. A process for treating a naturally occurring body of fluid, said process comprising:
providing a fine porous device;
positioning said fine porous device in said body of fluid;
passing a portion of said body of fluid through said fine porous device; and
transferring said portion of said body of fluid to a location away from a remainder of said body of fluid.

2. The process of claim 1 wherein said body of fluid includes at least one undesired component, said process further comprising:
blocking at least a portion of said at least one undesired component with said fine porous device such that said portion of said at least one undesired component is left in said remainder of said body of fluid.

3. The process of claim 2 wherein said at least one undesired component is selected from the group consisting of sediment, solids suspended in said body of fluid, pathogens, contaminants, germs, and microorganisms.

4. The process of claim 3 wherein said pathogens are selected from the group consisting of bacteria, protozoa, amoeba, and viruses.

5. The process of claim 3 wherein said microorganisms are selected from the group consisting of giardia cysts, cryptosporidium, pseudomonas, E-coli, legionella, bacteria, coliform, protozoan oocysts, algae, and viruses.

6. The process of claim 3 wherein said solids suspended in said body of fluid are selected from the group consisting of metals, inorganic solids, and organic compounds.

7. The process of claim 1 wherein said fluid is selected from the group consisting of water and air.

8. The process of claim 1 further comprising:
providing a screen;
positioning said screen in said body of fluid such that said portion of said body of fluid passes first through said screen and then through said fine porous device.

9. The process of claim 1 further comprising:
providing a pump;
positioning said pump in said body of fluid, said pump adapted to induce a flow of said portion of said body of fluid; and
inducing said portion of said body of fluid to pass through said fine porous device.

10. The process of claim 1 further comprising:
providing a pump; and
placing said pump in fluid communication with said portion of said body of fluid;
wherein said pump is used to transfer said portion of said body of fluid to said location away from said remainder of said body of fluid.

11. The process of claim 1 further comprising:
providing a structural support; and
securing said fine porous device to said structural support;
wherein said fine porous device and said structural support are adapted to be positioned in said body of fluid.

12. The process of claim 11 wherein said structural support is a housing.

13. The process of claim 1 further comprising:
providing a pump;
placing said pump in fluid communication with said fine porous device and another source of a fluid; and
pumping said fluid from said another source into said body of fluid to clean said fine porous device.

14. The process of claim 1 wherein said fine porous device is selected from the group consisting of ultrafilter membranes, microporous membranes, porous membranes, microscreens, nanofilters, reverse osmosis membranes, and particle filters.

15. A process for treating a naturally occurring body of water, said body of water including at least one undesired component, said process comprising:
providing a fine porous device, a structural support, a screen, and a first pump;
securing said fine porous device to said structural support;
positioning said fine porous device, said structural support, and said screen in said body of water;
passing a portion of said body of water through said screen and then through said fine porous device;
blocking at least a portion of said at least one undesired component with said fine porous device such that said portion of said at least one undesired component is left in a remainder of said body of water;
placing said first pump in fluid communication with said portion of said body of water, said first pump adapted to transfer said portion of said body of water to a location away from said remainder of said body of water; and
transferring said portion of said body of water to said location away from said remainder of said body of water.

16. The process of claim 15 further comprising:
providing a second pump;
positioning said second pump in said body of water, said second pump adapted to induce a flow of said portion of said body of water; and
cleaning said fine porous device by inducing said portion of said body of fluid to pass across and scour said fine porous device.

17. The process of claim 15 further comprising:
placing said first pump in fluid communication with said fine porous device and another source of a fluid ; and
pumping said fluid from said another source into said body of water to clean said fine porous device.

18. A fluid treatment system fluid comprising:
a naturally occurring body of fluid including at least one undesired component;
a screen positioned in said body of fluid;
a fine porous device positioned in said body of fluid such that a portion of said body of fluid is adapted to pass through said screen and then through said fine porous device, said fine porous device adapted to block at least a portion of said at least one undesired component when said portion of said body of fluid passes through said fine porous device;
a conduit having a first end portion and a second end portion, said first end portion positioned in said body of fluid such that it is adapted to be in fluid communication with said portion of said body of fluid that has passed through said fine porous device, said second end portion positioned outside of said body of fluid; and
a first pump located outside of said body of fluid and connected to said second end portion of said conduit, said first pump adapted to transfer said portion of said body of fluid to said second end portion of said conduit.

19. The fluid treatment system of claim 18 further comprising:
a second pump positioned in said body of fluid, said pump adapted to induce a flow of said portion of said body of fluid such that said portion of said body of fluid passes across said fine porous device.

20. The fluid treatment system of claim 18 further comprising:
a structural support positioned in said body of fluid and secured to said fine porous device.
